(19) United States
(12) Patent Application Publication
(10) Pub. No.: US 2011/0044693 A1
(43) Pub. Date: Feb. 24, 2011

(54) SYSTEM AND APPARATUS FOR PROVIDING A HIGH QUALITY OF SERVICE NETWORK CONNECTION VIA PLASTIC OPTICAL FIBER

(76) Inventors: Bradley George Kelly, Port Moody (CA); Alexander Gordon Dunfield, Burnaby (CA); Edward Matthew Rooyakkers, Burnaby (CA)

Correspondence Address: DAVIS WRIGHT TREMAINE, LLP/Seattle, 1201 Third Avenue, Suite 2200, SEATTLE, WA, 98101-3045, US

(21) Appl. No.: 12/811,679

(22) PCT Filed: Jan. 5, 2009
(86) PCT No.: PCT/CA09/00017

§ 371 Date: Nov. 10, 2010

Related U.S. Application Data
(60) Provisional application No. 61/019,225, filed on Jan. 4, 2008.
(60) Provisional application No. 61/030,900, filed on Feb. 22, 2008.

(51) Int. Cl. H04B 10/02; H04B 10/12

(52) U.S. Cl. 398/116

(57) ABSTRACT

A media converter for converting between electrical and optical signals is provided. The media converter includes an electro-optical transceiver configured to convert an optical signal into an electrical signal and vice-versa. The electro-optical transceiver includes an optical signal port connectable to a plastic optical fiber, the optical signal port for sending and receiving the optical signal along the plastic optical fiber; and an electrical signal port for sending and receiving the electrical signal. The media converter also includes a plurality of means for electrically conveying the electrical signal. A switch is in electrical communication with the electrical signal port of the electro-optical transceiver and with the plurality of means for electrically conveying the electrical signal, and is configured to direct the electrical signal from the electro-optical transceiver to any one of the means for electrically conveying the electrical signal and vice-versa, thereby facilitating bi-directional communication. The media converter can also have a telephonic network access port connectable to a telephone cable, which includes a pair of power carrying wires for carrying electrical power. A power supply is in electrical communication with the switch and the electro-optical transceiver, and power supply wiring electrically couples the telephonic network access port to the power supply for powering the media converter by transmitting power from the power carrying wires to the power supply when the telephone cable is coupled to the network access port. Beneficially, by obtaining power from the telephonic network, a low voltage telecommunications technician is able to install the media converter within a building, thereby allowing for relatively inexpensive installation.

### FIELD OF THE INVENTION

The present invention relates to a system and apparatus for providing a network connection via an optical fiber composed of plastics material (hereinafter “plastic optical fiber” or “POF”). Specifically, the present invention relates to a system and apparatus for providing a high quality of service (“QOS”) network connection via POF suitable for high bandwidth applications.

### BACKGROUND OF THE INVENTION

Increasingly, consumers are relying on packet switched networks for the delivery of content. An ubiquitous example of such reliance is the delivery of a myriad of different types of content via the Internet. In order to facilitate the delivery of content via the Internet, it is common for consumers to have high-speed, or broadband, Internet connections. While these broadband connections provide much greater bandwidth than older connections available over a traditional public switched telephone network, even when using such a broadband connection, obtaining the high QOS network access required for high bandwidth content can be problematic.

Content in the form of video is one type of high bandwidth content that is very sensitive to the network limitations inherent in most broadband Internet connections used today. This video content can take the form of both video content transmitted over the Internet, and Internet Protocol Television (“IPTV”), which transmits video content over private networks distinct from the Internet. In both cases, a delay in transmitting packets can result in signal degradation in the form of pixelization or, at worst, a blank video screen, both of which being unacceptable to consumers. Such signal degradation can be remedied by increasing the bandwidth available to the consumer.

One problem currently faced in increasing bandwidth is providing a suitable “last mile” network infrastructure. The “last mile” refers to the final leg of delivering connectivity from a communications provider to a consumer, and includes the wiring that provides connectivity within residences such as houses or apartment buildings, for example. Wiring that relies on electrical signals to convey content through the last mile, such as standard category 5, 5e, and 6 cables (“Ethernet cables”) used in traditional Ethernet applications, can be susceptible to noise or interference that results in signal degradation. Such noise or interference is generally non-periodic, cross-coupled “spiky” or “transient” interference (hereinafter collectively referred to as “transients”). Transients can be caused by using certain twisted pairs within the Ethernet cables for traditional telephony signals, which signals are inductively coupled to and consequently cause transients in the twisted pairs used for Ethernet signals. Transients are also caused by running the category 5/5e/6 cable in close proximity to alternating current (“AC”) power lines within the house or apartment building, which lines are also inductively coupled to and consequently cause transients in the Ethernet cables. In either case, the result of such transients is that the common-mode rejection benefits associated with Ethernet cables that result from their shielding and use of differential signalling are overwhelmed by the transients, and the transmission of Ethernet signals is noticeably impeded.

In order to compensate for transients, telecommunication companies are forced to install multiple, shielded runs of cable within a building using multiple conduits spaced significantly from cables carrying AC power or traditional telephony signals, which dramatically increases installation costs. An additional drawback to this method of installation is that not all Ethernet jacks available to the consumer within the building will be capable of supplying a high QOS network connection, and consequently a builder or contractor has to pre-select which Ethernet jacks within the building are going to be connected to cables that are capable of providing a consistently high QOS network connection, and which Ethernet jacks are not. Thus, in addition to increasing installation complexity and costs, this method of installation can result in a system that is cumbersome for the consumer to use.

Consequently, there exists a need for a system and apparatus that can provide a network connection with a high QOS to a consumer that improves on at least one of the above-noted deficiencies of the prior art.

### SUMMARY OF THE INVENTION

According to a first aspect of the invention, there is provided a media converter. The media converter includes an electro-optical transceiver configured to convert an optical signal into an electrical signal and vice-versa, the electro-optical transceiver having an optical signal port connectable to a plastic optical fiber, the optical signal port for sending and receiving the optical signal along the plastic optical fiber; and an electrical signal port for sending and receiving the electrical signal. The media converter also includes a plurality of means for electrically conveying the electrical signal; a switch in electrical communication with the electrical signal port of the electro-optical transceiver and with the plurality of means for electrically conveying the electrical signal, the switch configured to direct the electrical signal from the electro-optical transceiver to any one of the means for electrically conveying the electrical signal and vice-versa, thereby facilitating bi-directional communication; a telephonic network access port connectable to a telephone cable, the telephone cable comprising a pair of power carrying wires for carrying electrical power; a power supply in electrical communication with the switch and the electro-optical transceiver; and power supply wiring electrically coupled to the telephonic network access port and to the power supply for powering the media converter by transmitting power from the power carrying wires to the power supply when the telephone cable is coupled to the network access port.

The telephone cable can have a pair of data carrying wires for transmitting telephonic data; and the media converter may further include a telephone jack; and data wiring electrically coupling the telephone jack to the pair of data carrying wires when the telephone cable is coupled to the network access port, thereby facilitating telephonic communication.

The media converter may further include a feedthrough transceiver configured to convert a second optical signal into a second electrical signal and vice-versa, the feedthrough transceiver having an optical signal port connectable to a second plastic optical fiber, the optical signal port for sending and receiving the second optical signal along the second plastic optical fiber; and an electrical signal port for sending and receiving the second electrical signal. The switch can be in electrical communication with the electrical signal port of the feedthrough transceiver and is further configured to direct the electrical signal from the electrical signal port of the electro-optical transceiver to the electrical signal port of the feedthrough transceiver, thereby facilitating daisy-chaining of media converters via the feedthrough transceiver.

The means for electrically conveying the electrical signal may be a wireless connectivity module in electrical communication with the switch; and an antenna in electrical communication with the wireless connectivity module.

The means for electrically conveying the electrical signal may also be a network jack in electrical communication with the switch and configured to be electrically coupled to a cable for conveying the electrical signal.

According to a further aspect of the invention, there is provided a media converter having a housing and having a networking circuitry printed circuit board and a power circuitry printed circuit board inside the housing. The networking circuitry printed circuit board and the power circuitry printed circuit board are stacked on each other within the housing. The networking circuitry printed circuit board has mounted thereon an electro-optical transceiver and configured to convert an optical signal into an electrical signal and vice-versa, the electro-optical transceiver having an optical signal port protruding through the housing and connectable to a plastic optical fiber, the optical signal port for sending and receiving the optical signal along the plastic optical fiber; and an electrical signal port contained within the compact housing for sending and receiving the electrical signal. The networking circuitry printed circuit board also has mounted thereon a plurality of means for electrically conveying the electrical signal; and a switch in electrical communication with the electrical signal port of the electro-optical transceiver and with the plurality of means for electrically conveying the electrical signal, the switch configured to direct the electrical signal from the electro-optical transceiver to any one of the means for electrically conveying the electrical signal and vice-versa, thereby facilitating bi-directional communication. The power circuitry printed circuit board has mounted thereon a power supply in electrical communication with the switch and the electro-optical transceiver.

The media converter may also include an electrical plug in electrical communication with the power supply and for insertion into a power outlet, the electrical plug protruding from the housing such that when the electrical plug is inserted into the power outlet, the housing is pressed flush against the power outlet.

Alternatively, the media converter may include electrical contacts in electrical communication with the power supply and disposed on the housing. The housing may have a height of about 2.7 inches, a width of about 3.8 inches and a depth of about 1.6 inches and the media converter may also include a power outlet disposed on a faceplate of the housing and in electrical communication with the electrical contacts.

The networking circuitry printed circuit board can also have mounted thereon a feedthrough transceiver configured to convert a second optical signal into a second electrical signal and vice-versa, the feedthrough transceiver having an optical signal port protruding through the housing and connectable to a second plastic optical fiber, the optical signal port for sending and receiving the second optical signal along the second plastic optical fiber; and an electrical signal port for sending and receiving the second electrical signal. The power supply of the media converter is in electrical communication with the feedthrough transceiver; and the switch is in electrical communication with the electrical signal port of the feedthrough transceiver and is further configured to direct the electrical signal from the electrical signal port of the electro-optical transceiver to the electrical signal port of the feedthrough transceiver, thereby facilitating daisy-chaining of media converters via the feedthrough transceiver.

The means for electrically conveying the electrical signal may be a wireless connectivity module in electrical communication with the switch; and an antenna in electrical communication with the wireless connectivity module; and the power supply is in electrical communication with the wireless connectivity module.

Alternatively, the means for electrically conveying the electrical signal comprises a network jack in electrical communication with the switch and configured to be electrically coupled to a cable for conveying the electrical signal.

According to a further aspect of the invention, there is provided a system for facilitating bi-directional communication between a media converter and a packet-switched network. The system includes a network hub, which includes a network communication port in communication with the packet-switched network; a plurality of network hub electro-optical transceivers configured to convert an optical signal into an electrical signal and vice-versa, each network hub electro-optical transceiver having: an optical signal port connectable to a plastic optical fiber, the optical signal port for sending and receiving the optical signal along the plastic optical fiber and an electrical signal port for sending and receiving the electrical signal; and a network hub switch in electrical communication with the network communication port and in electrical communication with the electric signal ports of the plurality of network hub switch electro-optical transceivers, the network hub switch configured to direct the electrical signal from the network communication port to any one of the network hub electro-optical transceivers and vice-versa, thereby facilitating bi-directional communication. The system further includes a media converter according to any of the above aspects, and plastic optical fiber optically coupled at one end to the media converter and at another end to the network hub.

According to a further aspect of the invention, there is provided a system for facilitating bi-directional communication between a media converter and packet-switched and telephonic networks. The system includes a network hub, including a network communication port in communication with the packet-switched network; a plurality of network hub electro-optical transceivers configured to convert an optical signal into an electrical signal and vice-versa, each network hub electro-optical transceiver having an optical signal port connectable to a plastic optical fiber, the optical signal port for sending and receiving the optical signal along the plastic optical fiber and an electrical signal port for sending and receiving the electrical signal; and a network hub switch in electrical communication with the network communication port and in electrical communication with the electric signal ports of the plurality of network hub switch electro-optical transceivers, the network hub switch configured to direct the electrical signal from the network communication port to any one of the network hub electro-optical transceivers and vice-versa, thereby facilitating bi-directional communication. The system also includes a telephonic hub for sending and receiving electrical signals to and from the telephonic network; a media converter according to any aspects of the invention including a telephonic network access port; plastic optical fiber optically coupled at one end to the media converter and at another end to the network hub; and telephone cable electrically coupled at one end to the media converter and at another end to the telephonic hub.

One benefit of the invention is that the optical signals used to transmit network communications are inherently immune to interference from transients. Consequently, the media converters can be placed adjacent to sources of transient interference, and any plastic optical fiber present can be laid adjacent to sources of transient interference, without concern that transients will interfere with the optical signal carried along the plastic optical fiber. Consequently, it is much easier to lay plastic optical fiber for carrying network signals between the media converter and the network hub in conjunction with the present invention than it is to lay properly shielded electrical cables for the same purpose.

A further benefit of the invention is that POF is a much easier medium to handle than glass optical fiber, which can easily shatter and splinter into an installer's hand. Consequently, installing the POF that is used in conjunction with the invention can be done easily by a person not skilled in laying glass optical fiber, such as a low voltage telecommunications technician, thereby reducing the cost of the installation process.

A further benefit of the aspects of the invention configured to interface with a telephonic hub is that power can be drawn via the telephonic hub as opposed to from the alternating current (AC) power mains of a building. Consequently, a low voltage telecommunications technician can wire the power lines for the media converters as opposed to an electrician, thereby reducing installation costs.

A further benefit of the aspects of the invention having a power circuitry printed circuit board and a networking circuitry printed circuit board is that by separating the circuitry on to two printed circuit boards, a design that efficiently uses space is achieved, and the two printed circuit boards can be fitted within a compact housing, such as a standard gangbox.

### BRIEF DESCRIPTION OF THE DRAWINGS

In the accompanying drawings, which illustrate exemplary embodiments of the present invention:

FIG. 1 is a schematic of a system capable of providing a high QOS network connection to a consumer, according to one embodiment.

FIG. 2 is a block diagram of an 8-port POF switch that composes part of the system of FIG. 1.

FIGS. 3(a) and 3(b) are perspective views of the 8-port POF switch as depicted in FIG. 2.

FIGS. 3(c) and 3(d) are perspective views of an 8-port POF switch capable of wireless connectivity, according to a further embodiment.

FIG. 4 is a block diagram of a POF terminator having four RJ-45 jacks that composes part of the system depicted in FIG. 1.

FIG. 5 is a block diagram of a POF terminator having two RJ-45 jacks that composes part of the system depicted in FIG. 1.

FIG. 6 is a block diagram of a POF terminator having two RJ-45 jacks with wireless capability that composes part of the system depicted in FIG. 1.

FIGS. 7(a) and 7(b) are perspective views of the terminator as depicted in FIG. 4.

FIGS. 8(a) and 8(b) are perspective views of the terminator as depicted in FIG. 5.

FIGS. 9(a) and 9(b) are perspective views of the POF terminator with wireless capability as depicted in FIG. 6.

FIG. 10 is a schematic of a system capable of providing a high QOS network connection to a consumer according to a further embodiment wherein the POF terminators used in the system also allow a consumer to access a telephonic network.

FIG. 11 is a block diagram of a POF terminator having four RJ-45 jacks and two telephone jacks, and composing part of the system as depicted in FIG. 10.

FIG. 12 is a block diagram of a POF terminator having two RJ-45 jacks and two telephone jacks, and composing part of the system as depicted in FIG. 10.

FIG. 13 is a block diagram of a POF terminator having two RJ-45 jacks, wireless capability, and two telephone jacks, and which composes part of the system as depicted in FIG. 10.

FIGS. 14(a) and 14(b) are perspective views of the terminator as depicted in FIG. 11.

FIGS. 15(a) and 15(b) are perspective views of the terminator as depicted in FIG. 12.

FIGS. 16(a) and 16(b) are perspective views of the terminator as depicted in FIG. 13.

FIG. 17 is a block diagram of a POF terminator having four RJ-45 jacks according to a further embodiment wherein the terminator is contained within an alternative housing having an electrical plug for drawing power from an AC outlet.

FIG. 18 is a block diagram of a POF terminator having two RJ-45 jacks and wireless capability according to a further embodiment wherein the terminator is contained within an alternative housing having an electrical plug for drawing power from an AC outlet.

FIGS. 19(a) and 19(b) are perspective views of the terminator as depicted in FIG. 17.

FIGS. 20(a) and 20(b) are perspective views of the terminator as depicted in FIG. 18.

FIGS. 21(a) and 21(b) are perspective views of a terminator having four RJ-45 jacks mounted within a housing adjacent to AC power outlets.

### DETAILED DESCRIPTION OF EXEMPLARY EMBODIMENTS

In order for a consumer to access data on a packet-switched network, the consumer must establish a connection with the network. Such a connection often takes the form of a cable or digital subscriber line modem that acts as a bridge between the packet-switched network, which is typically a wide area network (“WAN”) such as the Internet, and a consumer's own local area network (“LAN”). Often, this connection only uses electrical signals to communicate between the WAN and consumer devices the consumer has coupled to the LAN. One problem associated with communication using electrical signals is that they are inherently susceptible to interference caused by transients, which can make it difficult for the consumer to obtain a network connection that has a high QOS.

Using glass optical fiber to convey content overcomes the problems caused by transients, but the equipment designed for use with glass optical fiber is generally designed for server-side industrial networking applications and is prohibitively expensive for residential and many typical commercial applications. Furthermore, glass optical fiber is a very difficult medium with which to work, further increasing installation costs.

Additionally, within almost all buildings exist traditional voice telephony systems wired using telephone cable such as category 3 cable that allow the consumer to access a telephonic network. Such telephone systems typically terminate in telephone jack such as a RJ-11 (6P4C) jack that is housed within a wall, into which a consumer can plug a conventional telephone. As such RJ-11 (6P4C) jacks are well known to telecommunications utilities and their technicians, it would be advantageous if a system for providing a network connection with a high QOS could be implemented in conjunction with existing voice telephony technology. Such a system for providing a high QOS network connection would be easier for a telecommunications utility to implement than a standalone system, as the system would utilize, at least in part, technology with which the telecommunications utility is already familiar.

All of the exemplary embodiments described herein utilize optical signals transmitted over POF to facilitate network communications, thereby greatly mitigating the effect of transients on data communications. Furthermore, some of the exemplary embodiments described herein allow power to be drawn from the telephonic network in order to power a media converter that is used to provide a high QOS network connection to the consumer.

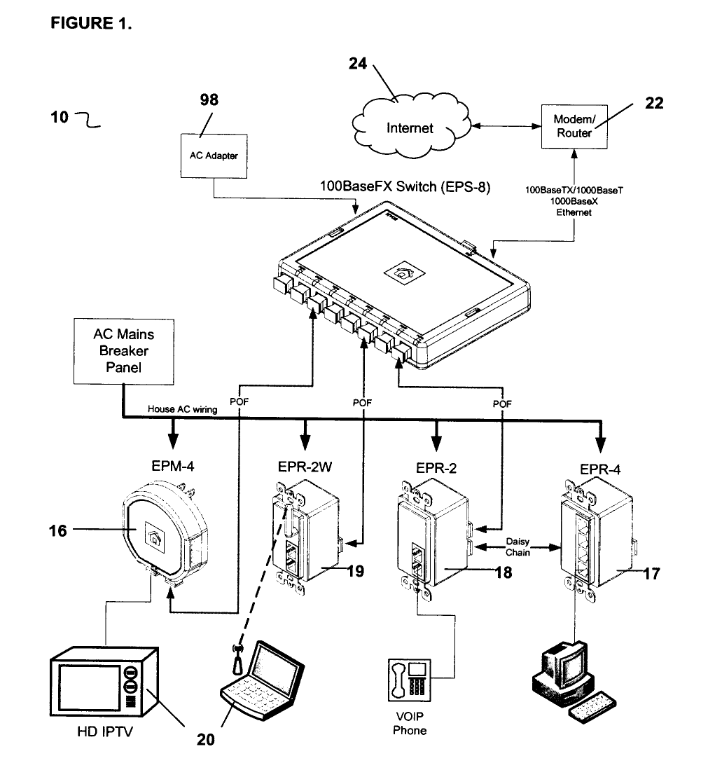

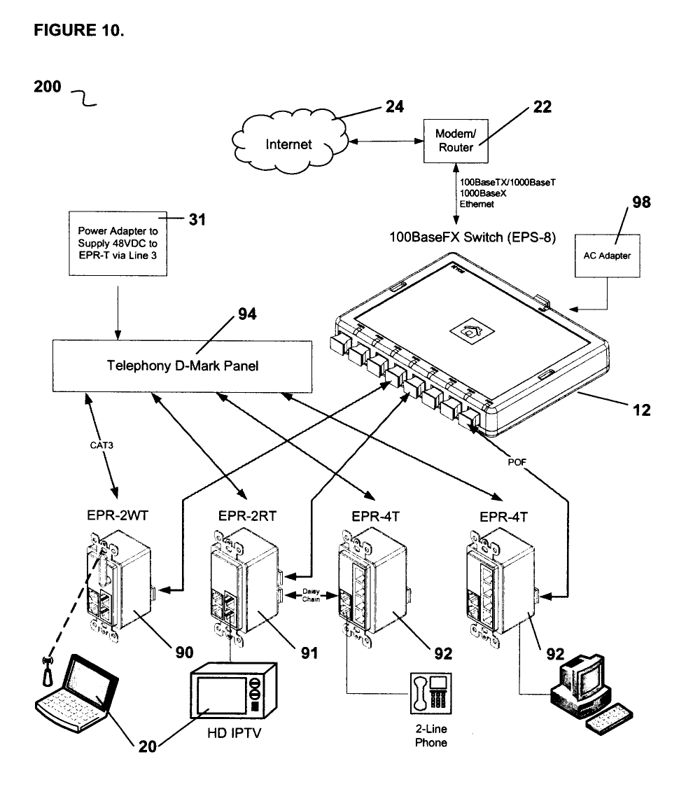

Referring first to FIGS. 1 and 10, there are depicted systems 10, 200 for facilitating bi-directional communication between a media converter and a packet-switched network. The systems 10, 200 use POF 14 to deliver network content to the consumer. In the embodiments of FIGS. 1 and 10, the systems 10, 200 have media converters in the form of POF terminators 15-20, 90-92 (terminators 15 and 20 not illustrated in FIGS. 1 and 10) that allow the consumer to access a packet-switched network in the form of a WAN 24, such as an ADSL Internet connection, using means for electrically conveying electrical signals, such as one or both of a typical Ethernet cable or a wireless connection. The POF terminators 90-92 in the system 200 as depicted in FIG. 10 also allow the consumer to access a traditional telephonic network via telephone jacks 116 present in the terminators 90-92. As described in further detail below, such an embodiment allows the existing telephonic networks present in many buildings, such as residences and businesses, to be utilized and leveraged in connection with the WAN 24 in order to provide both traditional telephony services and WAN access to consumers.

### Exemplary Embodiments Without Telephony Support

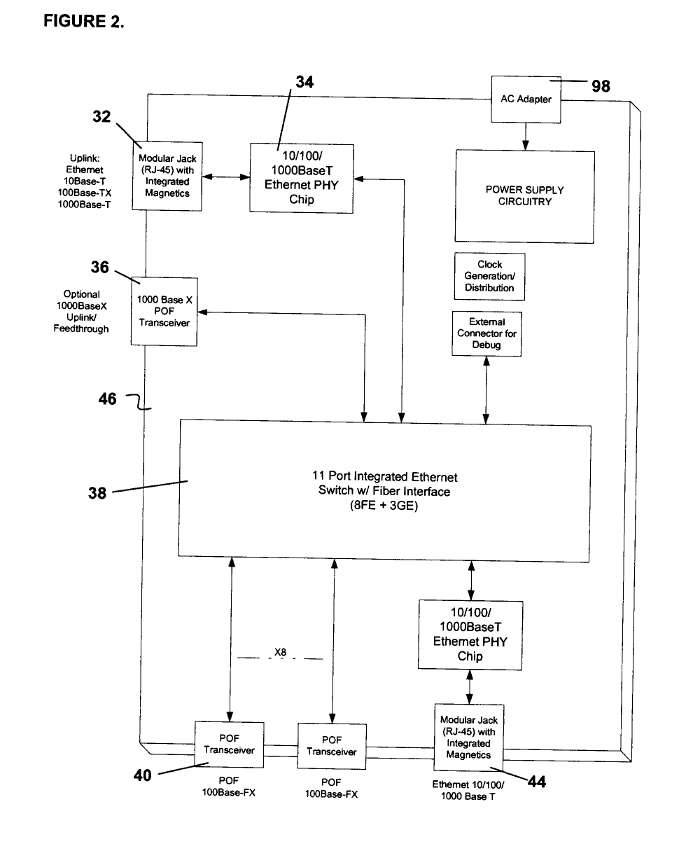

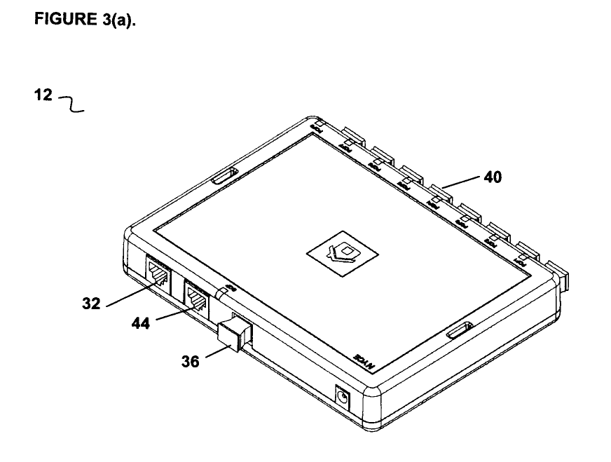

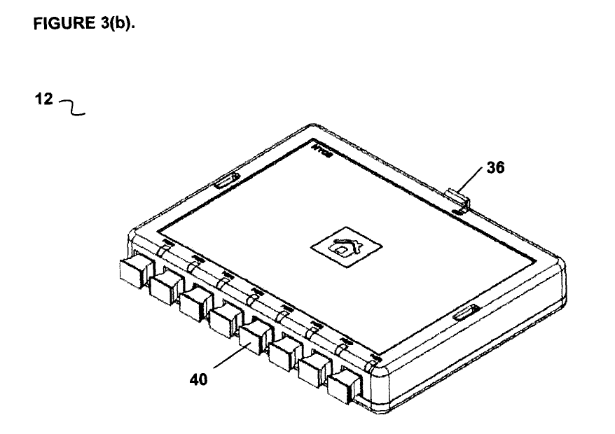

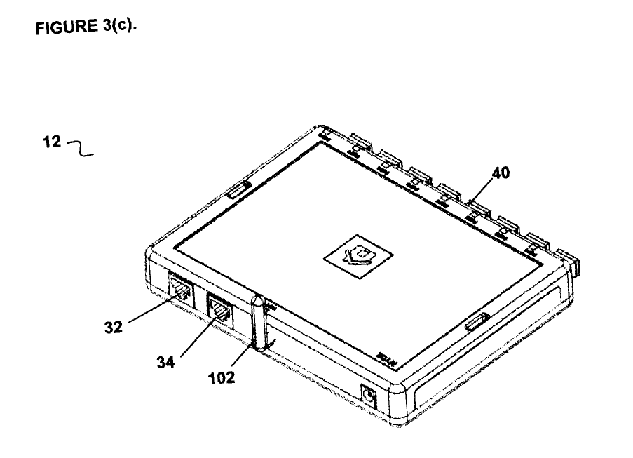

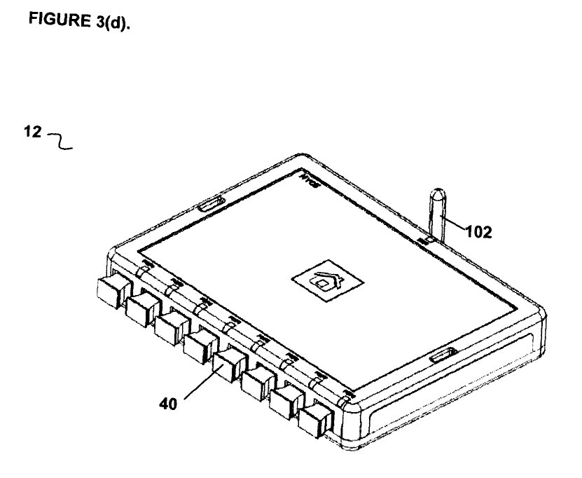

Referring now to FIG. 1, the system 10 is depicted as including a modem 22, such as a 2-wire Gateway 2700HG-E ADSL modem/router, that bridges the connection between the WAN 24 and the LAN, such as the 100BaseTX/1000BaseT/1000BaseX Ethernet used in this exemplary embodiment. The Ethernet connection from the modem 22 is then coupled to a network hub, which in this embodiment is an 8-port POF switch 12 (a 100BaseFX switch), which is discussed in more detail with reference to FIGS. 2 and 3, below. Instead of connecting an ADSL Internet connection to the modem 22, a privately held network's 10/100/1000 Base-T Ethernet connection, such as those used by cable companies to deliver IPTV, can be connected directly to the 8-port POF switch 12. For installations in a multi-dwelling unit (“MDU”) such as an apartment complex, for example, both the modem 22 and 8-port POF switch 12 are typically housed in a utility space to which multiple services (e.g.: cable, telephone) are directed before being routed throughout the MDU to individual units/residences. In the system 10, the 8-port POF switch 12 is coupled to the 100BaseTX/1000BaseT/1000BaseX electrical Ethernet on its upstream end and to up to eight ports transmitting 100BaseFX Ethernet transmitted over POF 14 on its downstream end. In this application, notwithstanding that the network 10 is bi-directional, “upstream” refers to points in the network nearer to the WAN 24, while “downstream” refers to points in the network nearer to the LAN. The POF 14 can be any suitable POF as is known to persons skilled in the art, such as Mitsubishi International Corporation's ESKA™ 2.2 mm POF. While the POF 14 in FIG. 1 is depicted schematically as one strand of POF, each optical port of the 8-port POF switch 12 is coupled to two strands of POF, one for transmitting and one for receiving data, consistent with the 100BaseFX standard.

The POF 14 is wired through a consumer's residence or commercial building, for example. By using the POF 14 for wiring, the problem of transients affecting the data transmitted on electrical Ethernet cables, such as standard category 5, 5e, or 6 cables, is eliminated. This is because transients inherently affect only electrical signals, and the signal transmitted along the POF 14 is optical. With transients eliminated, signal interference decreases and a high QOS can be ensured. Consequently, when the POF 14 is being laid in a building, extra care does not have to be taken to separately install shielded conduits that house Ethernet cables, which results in a simpler installation and cost savings. Furthermore, the POF 14 can be easily installed by an electrician or by a low-voltage telecommunications technician, as the POF 14 is a resilient, easy-to-handle medium that can be safely cut using means such as an X-acto™ knife. This is in contrast to glass optical fiber, which easily shatters, and which therefore cannot be installed at low cost by an electrician or by a low-voltage telecommunications technician.

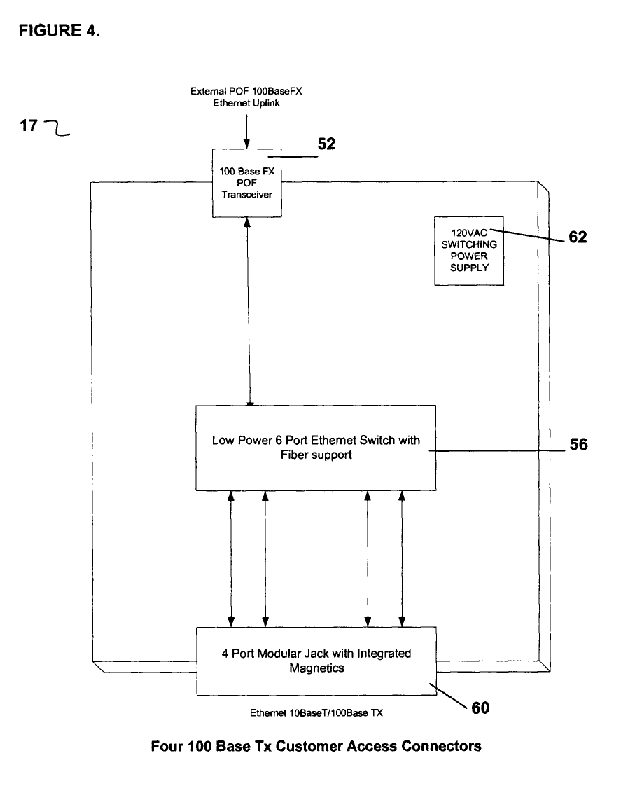

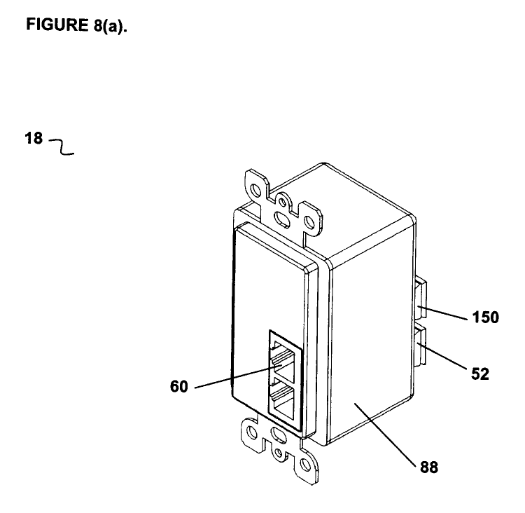

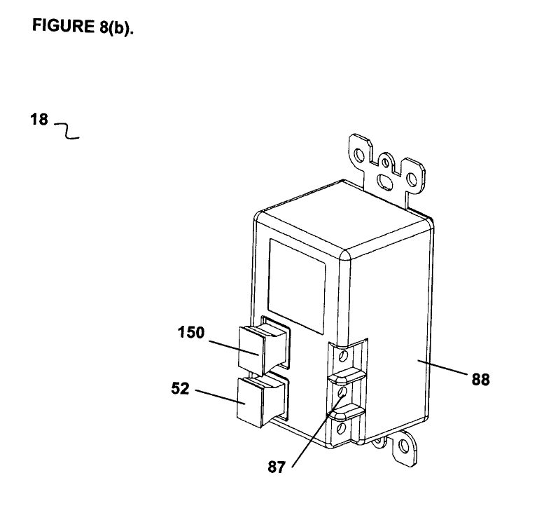

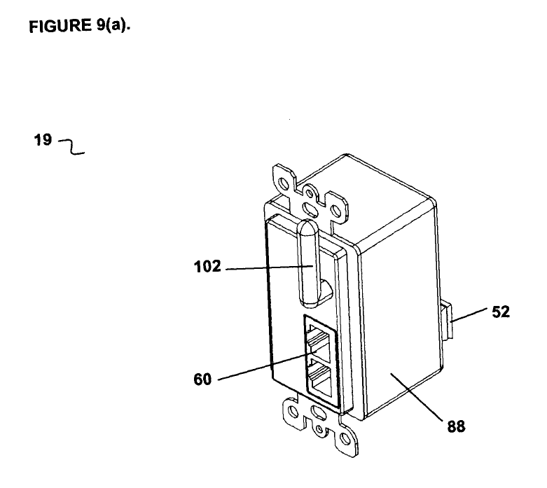

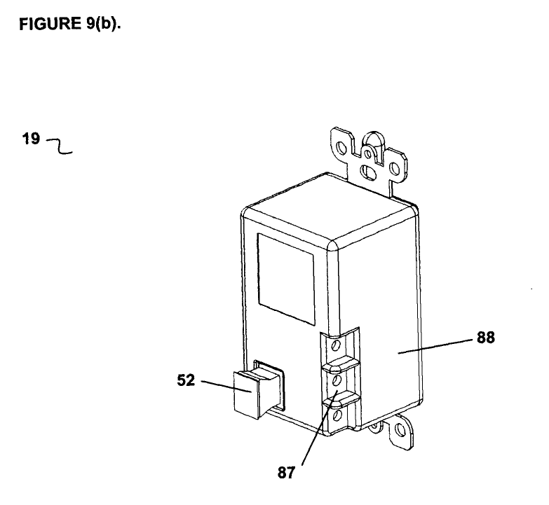

Each of the POF 14 pairs terminates in one of the terminators 16-19, each of which converts the optical Ethernet signal back into an electrical Ethernet signal for use by a consumer device 21 such as a computer or television. The terminators 16-19 are discussed in more detail with reference to FIGS. 4-9, below.

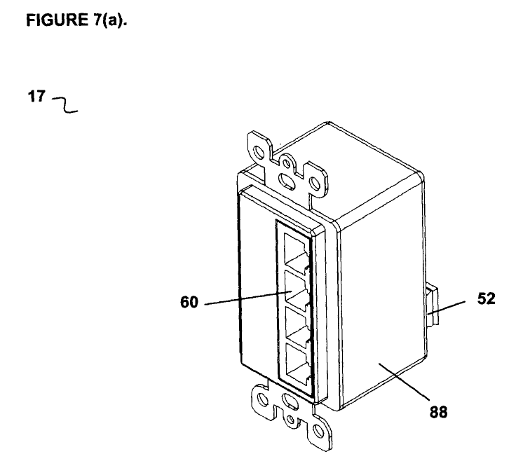

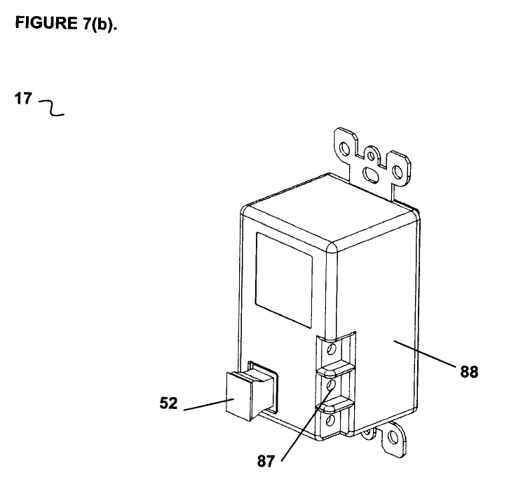

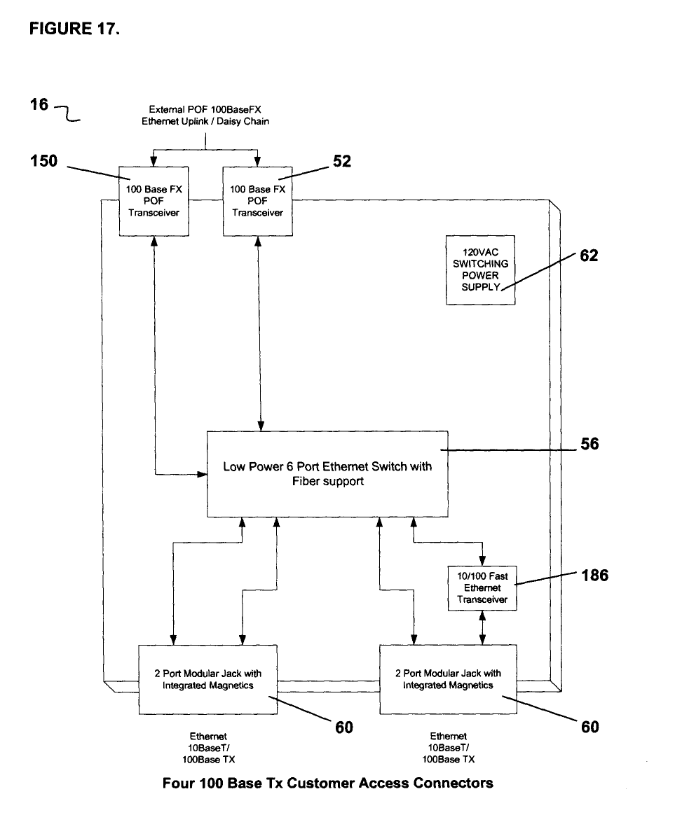

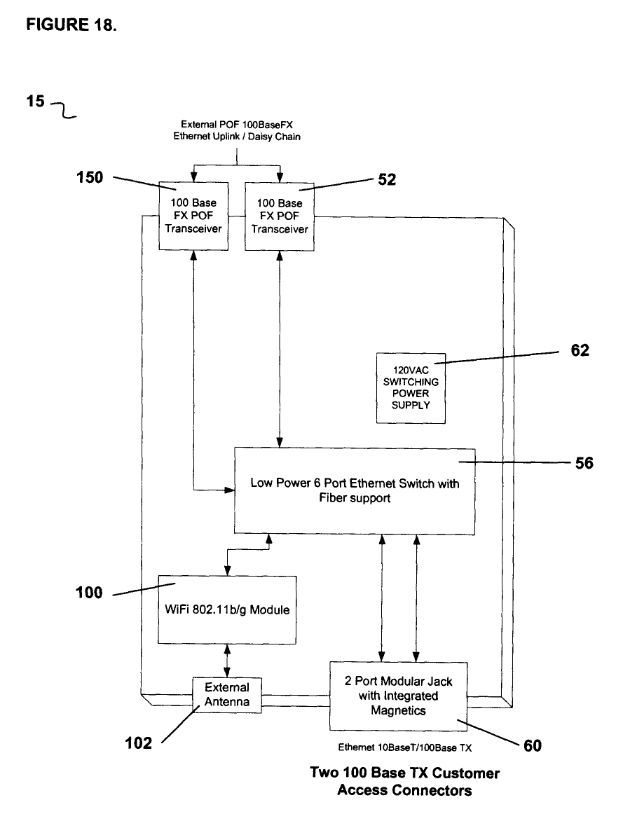

As transients are not an issue with the POF 14 used in the network 10, the POF 14 can be laid adjacent to standard electrical wiring. Consequently, and as discussed in more detail with respect to FIGS. 7-9, below, each of the terminators 17,-19 can be contained within a housing 88 that can unobtrusively be fitted within the walls of a building. Using the housings 88 to enclose the terminators 17-19 has the benefit that convenient access to the system 10 can be provided in a relatively inconspicuous manner by routing the POF 14 within a wall where it is hidden from view, by terminating the POF 14 within the terminators 17-19 and by then allowing the consumer to easily access the system 10 via a wired (in the case of the terminators 17-19) or wireless (in the case of the terminator 19) connection. According to an alternative embodiment, and as discussed in more detail with reference to FIGS. 17 and 18 below, the terminator 16 and an additional embodiment of a POF terminator 15 (not depicted in FIG. 1) can each be contained within an alternative housing 64 that has an electrical plug for insertion into an AC power outlet.

Referring now to FIG. 2, there is depicted a block diagram of the 8-port POF switch 12 that acts as the network hub. On the upstream side there is an electrical 10Base-T/100Base-TX/1000Base-T Ethernet uplink via a network communication port in communication with the packet-switched network, the WAN 24. In this embodiment, the network communication port is an RJ-45 jack 32. Also on the upstream side is an optional 1000BaseX fiber uplink via a 1000BaseX POF transceiver 36. A typical RJ-45 jack 32 used is a Pulse Magnetics JK0654219 jack; an exemplary 1000BaseX POF transceiver 36 used is the Firecomms™ EDL1000G-510 transceiver. Directly coupled to the RJ-45 jack 32 is a 10/100/1000BaseT Ethernet PHY chip 34, such as the Marvell™ 88E1111, used for Ethernet transmissions. Both the RJ-45 jack 32 and the POF transceiver 36 are in electrical communication with and transmit electrical signals to a network hub switch, which in this embodiment is an 11-port Ethernet integrated switch 38. The 11-port Ethernet integrated switch 38 may, for example, be a Marvell™ 88E6097. The 11-port Ethernet integrated switch 38 electrically couples the upstream RJ-45 jack 32 and POF transceiver 36 to network hub electro-optical transceivers, which in this embodiment are eight 100 Base FX POF transceivers 40, and to another RJ-45 jack 44 downstream. Each of the eight POF transceivers 40 may be, for example, a Firecomms™ EDL300T transceiver. Each of the eight POF transceivers 40 has an optical signal port connectable to the POF 14 and an electrical signal port connectable to the 11-port Ethernet integrated switch 38. The 11-port Ethernet integrated switch 38 is configured to direct the electrical signal from the RJ-45 jack 32 to any of the eight POF transceivers 40 and vice-versa, thereby facilitating bi-directional communication. Each of the eight POF transceivers 40 outputs 100Base-FX Ethernet on to pairs of the POF 14, and the downstream RJ-45 jack 44 is coupled to the 11-port Ethernet integrated switch 38 via a PHY chip 42 and outputs electrical 10/100/1000 Base-T Ethernet signals. The 11-port Ethernet integrated switch 38 can interface with the PHY chips 34, 42 using any appropriate interface, such as the SGMII, GMII, RGMII, or MII interfaces. No separate PHY chips are required between the 11-port Ethernet integrated switch 38 and the POF transceivers 36, 40, as the 11-port Ethernet integrated switch 38 has integrated PHY-level drives (not shown) for directly driving the POF 14 or other fiber devices. Power, clock, and debug circuitry 46 is also present. Power is obtained from an AC adapter 98.

Notably, although in this exemplary embodiment the 8-port POF switch 12 is configured such that it couples upstream signals from the WAN 24 to the POF 14 via the RJ-45 jack 32, the 8-port POF switch 12 can also be alternatively configured. For example, the 8-port POF switch 12 can be set to transmit signals between either the RJ-45 jack 32 or any of the eight POF transceivers 40 to the POF transceiver 36.

FIGS. 3(a) and 3(b) are perspective views of the 8-port POF switch 12. Visible are the eight POF transceivers 40 and the two RJ-45 jacks 32, 44.

FIGS. 3(c) and 3(d) are perspective views of the 8-port POF switch 12 wherein in lieu of the POF transceiver 36, an external antenna 140 provides the 8-port POF switch 12 with wireless connectivity. The external antenna 140 is coupled internally to a wireless connectivity module (not shown in FIG. 2 or 3), such as a Broadcom BCM5352 chip-set or an Aethos AR5002AP-2X chip-set, which is then coupled to the 11-port integrated Ethernet switch 38. The wireless connectivity can be used to wirelessly couple the modem 22 to the 8-port POF switch 12.

Referring now to FIG. 4, there is depicted a block diagram of the terminator 17. The terminator 17 has as an upstream connector an electro-optical transceiver in the form of a 100 Base FX POF Transceiver 52, such as a Firecomms™ EDL300T transceiver. The POF transceiver 52 connects to the POF 14 via an optical signal port, thereby coupling the terminator 17 to the 8-port POF switch 12. The POF transceiver 52 is in electrical communication with a 6-port Ethernet switch 56 with fiber support via an electrical signal port. The 6-port Ethernet switch 56 may be a Marvell™ 88E6061, and electrically couples the POF transceiver 52 to means for electrically conveying an electrical signal, which in this case is a network jack in the form of any of four RJ-45 jacks 60 which are configured to be electrically coupled to Ethernet cables (not shown) for supplying a network connection to consumer devices 21. As the terminator 17 has four RJ-45 jacks 60, the terminator 17 is a “four-port terminator”. The 6-port Ethernet switch 56 is configured to direct the electrical signal from the POF transceiver 52 to any of the four RJ-45 jacks 60 and vice-versa, thereby facilitating bi-directional communication. The 6-port Ethernet switch 56 used in this exemplary embodiment has four integrated Fast Ethernet transceivers (not shown) that allow the four RJ-45 jacks 60 to be directly coupled to the switch 56; consequently, no external transceiver (such as the PHY chips 34, 42) must be coupled between the 6-port Ethernet switch 56 and any of the RJ-45 jacks 60. A power supply 62 in electrical communication with the 6-port Ethernet switch 56 and the POF transceiver 52 and that obtains power from an AC power supply is present, as are clock and debug circuitry (not shown).

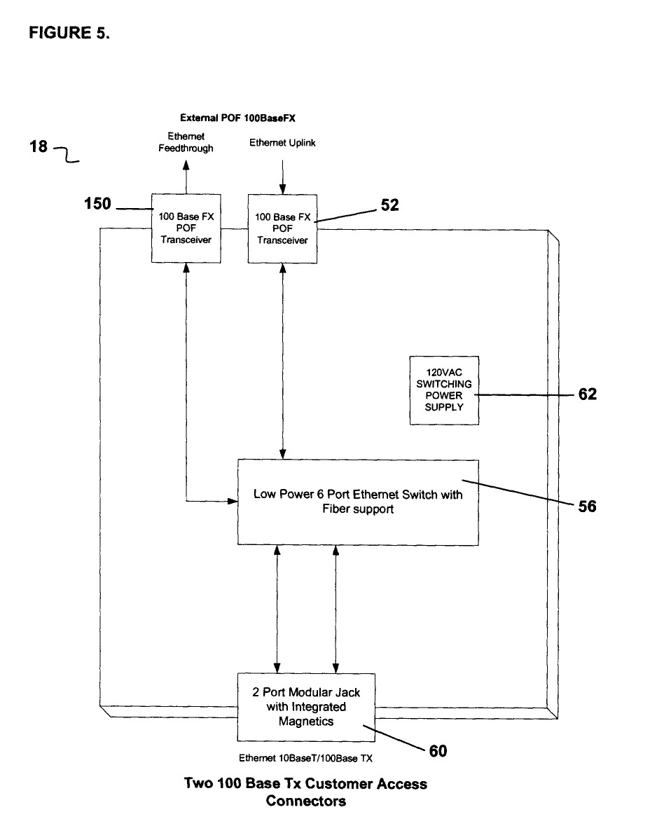

Referring now to FIG. 5, there is depicted a block diagram of the terminator 18. As with the terminator 17, the terminator 18 has as an upstream connector an electro-optical transceiver in the form of a 100 Base FX POF Transceiver 52 connectable to POF 14 via an optical signal port and electrically coupled to a 6-port Ethernet switch 56 with fiber support via an electrical signal port. Any suitable interface may be used to electrically couple the POF transceiver 52 to the 6-port Ethernet switch 56, such as the SGMII, GMII, RGMII, or MII interfaces. The terminator 18 also has a second 100 Base FX POF Transceiver 150 (the “feedthrough transceiver”) that can be used to daisy-chain the terminator 18 to the other terminators 15-19, 90-92. The feedthrough transceiver 150 is connectable to POF 14 via an optical signal port and is connectable to the 6-port Ethernet switch 56 via an electrical signal port. The 6-port Ethernet switch is configured to direct the electrical signal from the POF transceiver 52 to the feedthrough transceiver 150, thereby facilitating daisy-chaining of media converters. This allows these other terminators 15-19, 90-92 to receive an optical signal via the feedthrough transceiver as opposed to directly from the 8-port POF switch 12. Such functionality is beneficial as it allows the ports on the 8-port POF switch 12 to be conserved. The 6-port Ethernet switch 56 is directly electrically coupled to means for electrically conveying an electrical signal, which in this case is a network jack in the form of any of two RJ-45 jacks 60; consequently, the terminator 18 is a “two-port” terminator. As with the terminator 17, the power supply 62 that obtains power from an AC supply is present, as is clock and debug circuitry (not shown).

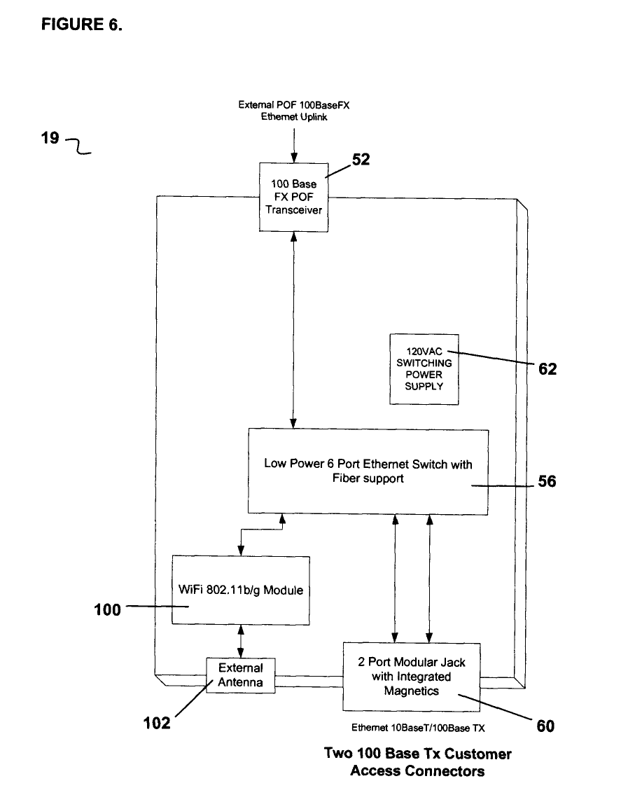

Referring now to FIG. 6, there is depicted a block diagram of the terminator 19, which supports wireless connectivity. The terminator 19 is the same as the terminator 18, with the exception that the terminator 19 has, in place of the feedthrough transceiver, means for electrically conveying an electrical signal, which in this case is a wireless connectivity module in electrical communication with the 6-port Ethernet switch 56 and an external antenna 102 in electrical communication with the wireless connectivity module. The depicted wireless connectivity module is a Wi-Fi™ 802.11b/g module 100 such as a Broadcom BCM5352 chip-set or an Aethos AR5002AP-2X chip-set. The external antenna 102 protrudes from the terminator 19 and facilitates wireless communication with the consumer device 21.

FIGS. 7-9 show the terminators 17-19 mounted within the housing 88 that can be conveniently fitted within a wall, thereby allowing easy and ubiquitous access to a high QOS network connection. The housing 88 is in connection with the POF transceiver 52, the feedthrough transceiver 150 (for the terminator 18), and the RJ-45 jacks 60, and the 6-port Ethernet switch 56 is contained within the housing 88. Because the optical signal is not affected by transients, the terminators 17-19 can be placed adjacent to the sources of transients, such as AC power lines, without signal degradation resulting. The terminators 17-19 are typically mounted within a wall and are powered directly from standard 14-AWG 3-wire AC power mains (not shown) available in the residence, which can be directly coupled to electrical contacts 89 disposed on the housing 88 and in electrical communication with the power supply 62, thereby powering the terminators 17-19. The POF transceivers 52 of the terminators 17-19 can receive the POF 14 from the 8-port POF switch 12 or can receive the POF 14 that is daisy-chained via the feedthrough transceiver 150 of the terminator 18. This POF 14 can be routed under the baseboards or through the walls of a residence, for example, to reduce any detrimental aesthetic or functional effect on the residence. Benefits of mounting the terminators 17-19 within the housings 88 include ease of installation, as telecommunications technicians, electricians and consumers can easily terminate the POF into a convenient receptacle, and convenience of use, as the housings 88 can be located in several places in a typical home, and consequently can provide for easy and ubiquitous network access. Furthermore, in contrast to current high QOS network installations that rely on multiple runs of Ethernet cables, all network connections provided by this exemplary embodiment are capable of providing a high QOS network connection. The consumer can plug a device, such as a television or a computer, into any of the RJ-45 jacks 60 and access a network with a high QOS sufficient for IPTV, for example, as opposed to having to select a specific network jack that is coupled to Ethernet cabling that is sufficiently protected from transients to provide a high QOS connection.

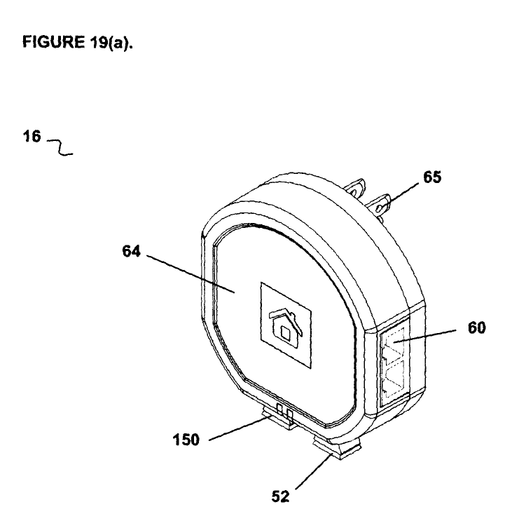

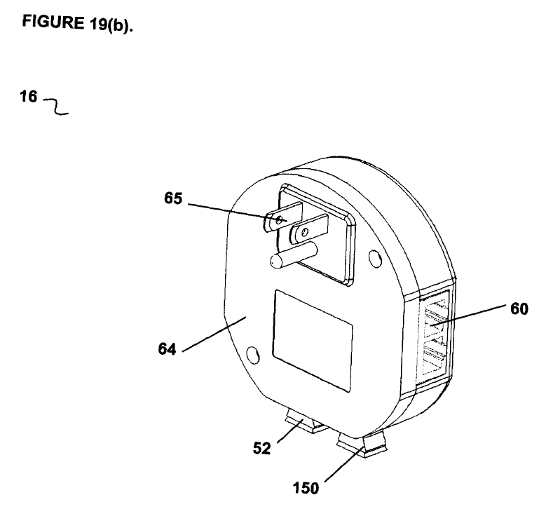

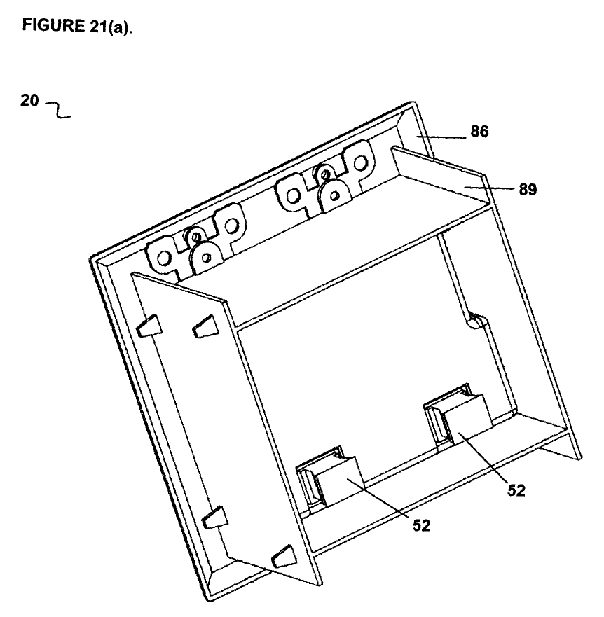

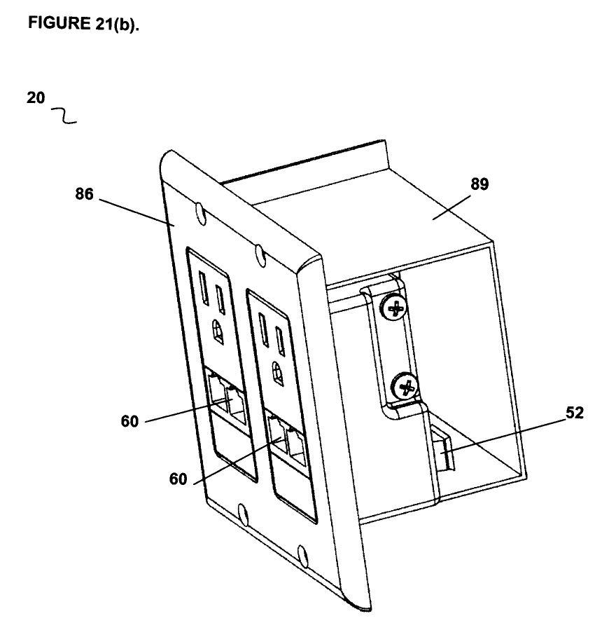

FIGS. 17-21 illustrate an embodiment of a terminator 16 mounted within the alternative housing 64 that can be inserted into a typical AC power outlet (not shown) using an electrical plug in the form of a 3-prong plug 65 that protrudes from the alternative housing 64 (FIGS. 17, 19(a) and 19(b)) and a terminator 15 with wireless support mounted within the alternative housing 64 such that it can also be plugged into a typical AC power outlet (not shown) using an electrical plug in the form of the 3-prong plug 65 (FIGS. 18, 21(a) and 21(b)), thereby providing easy and ubiquitous access to a high QOS network connection. The alternative housing 64 is in connection with the POF transceiver 52, the feedthrough transceiver 150, and the RJ-45 jacks 60, and the 6-port Ethernet switch 56 is contained within the alternative housing 64.

Referring now to FIG. 17, there is depicted a block diagram of the terminator 16 having as upstream connectors electro-optical transceivers in the form of 100 Base FX POF Transceivers 150, 52, which correspond in type and functionality to the feedthrough transceiver 150 and the POF transceiver 52 used in the terminator 17 as depicted in FIG. 4. The feedthrough transceiver 150 and the POF transceiver 52 can each receive an optical signal directly from the 8-port POF switch 12 or a signal that has been daisy-chained from the other terminators, and can also be used to daisy-chain the optical signal to the other terminators. Electrically coupled to the feedthrough transceiver 150 and the POF transceiver 52 is the 6-port Ethernet switch 56, which in turn is coupled to means for electrically conveying an electrical signal. In this case the means for electrically conveying an electrical signal is a network jack in the form of any of two, 2-port RJ-45 jacks 60. The 6-port Ethernet switch 56 and the RJ-45 jacks 60 are identical in type and functionality to those used in the terminator 17, with the exception that the jacks 60 are divided into two groups of two, instead of being one contiguous group of four. Interposed between the 6-port Ethernet switch 56 and one of the RJ-45 jacks 60 is a Fast Ethernet transceiver 186, such as a Marvell™ 88E3015 transceiver. The power supply 62 that obtains power from an AC outlet is present, as is clock and debug circuitry (not shown).

Referring now to FIG. 18, there is depicted a block diagram of the terminator 15, which has wireless capability. The terminator 15 is the same as the terminator 16, with the exception that the terminator 15 has in place of two of the RJ-45 jacks 60 alternative means for electrically conveying an electrical signal, which in this case is the wireless connectivity module in electrical communication with the external antenna 102 that protrudes from the terminator 19 and that facilitates wireless communication with the consumer device 21. The depicted wireless connectivity module is a Wi-Fi™ 802.11b/g module 100 such as a Broadcom BCM5352 chip-set or an Aethos AR5002AP-2X chip-set.

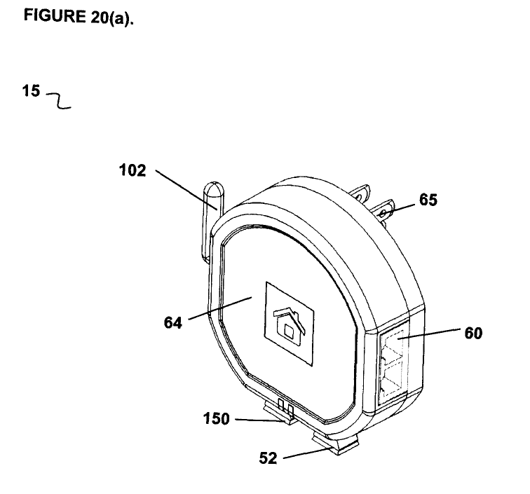

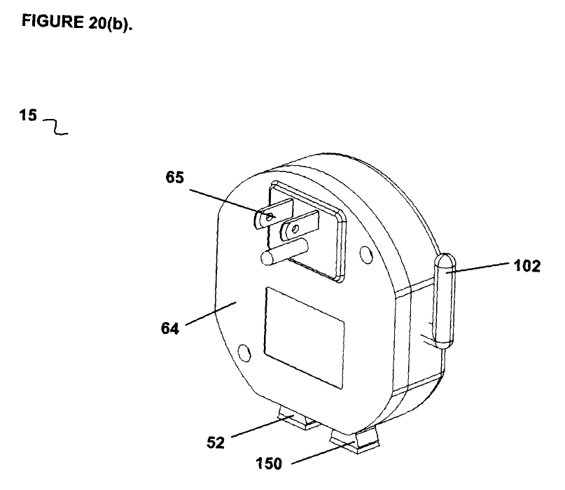

Referring now to FIGS. 19 and 20, there are depicted perspective views of the terminators 15, 16. Because the optical signal is not affected by transients, the terminators 15, 16 can be placed adjacent to the electrical circuitry present in AC outlets without suffering signal degradation. The feedthrough transceiver 150, the POF transceiver 52 of the terminators 15, 16 are in connection with the alternative housing 64, can receive the POF 14 daisy-chained from other terminators or directly from the 8-port POF switch 12, and can be used to daisy-chain an optical signal to other terminators. The RJ-45 jacks 60 are also in connection with the alternative housing 64. Such POF 14 can be routed under the baseboards of a residence, for example, to reduce any detrimental aesthetic or functional effect on the residence. Benefits of mounting the terminators 15, 16 on AC power outlets include ease of installation, as consumers can easily install the terminators 15, 16 by themselves, and convenience of use, as AC outlets are located in several places in a typical home, and consequently can allow for ubiquitous network access. Furthermore, in contrast to current high QOS network installations that rely on multiple runs of Ethernet cables, all network connections provided by this exemplary embodiment are capable of providing a high QOS network connection. A consumer can couple the consumer device 21, such as a television or a computer, into any of the jacks 60 of the terminators 15, 16 and access a network with a high QOS sufficient for IPTV, for example, as opposed to having to select a specific network jack that is coupled to Ethernet cabling that is sufficiently protected from transients to provide a high QOS connection.

As transients do not affect optical signals, a terminator 20 as depicted in FIGS. 21(a) and (b) is also possible. The block diagram of the terminator 20 is the same as that of the terminator 17 in FIG. 4, with the exception that the means for electrically conveying an electrical signal is in this case is a network jack in the form of two RJ-45 jacks 60 instead of four RJ-45 jacks 60. The terminator 20 is contained within a standard AC gangbox 89 covered by a faceplate 86. Power outlets are disposed on the faceplate 86 of the gangbox 89 and the power outlets are in electrical communication with the alternating current power mains within a building. In this exemplary embodiment, the gangbox 89 of the transceiver 20 used is a set of Hubbell 2002R (dual) boxes. Such a gangbox 89 has a width of about 3.8 inches; a depth of about 1.6 inches; and a height of about 2.7 inches.

Exemplary Embodiments Having Telephony Support

Referring now to FIG. 10, there is depicted a system 200 for facilitating bi-directional communication between a media converter and packet-switched and telephonic networks. The system 200 uses the POF 14 to deliver packet-switched content to the consumers, and uses telephone cables to deliver content from the telephonic network to the consumers. Similar to the embodiment of the system 10 depicted in FIG. 1, the system 200 of FIG. 10 uses the modem 22 to bridge the WAN 24 and LAN. In this embodiment, the modem 22 outputs Ethernet signals, which are then coupled to the 8-port POF switch 12, to the POF 14, and eventually to terminators 90-92 that allow the consumer to access network content.

In contrast to the system 10 depicted in FIG. 1, however, and as discussed in greater detail below, the terminators 90-92 all have telephone jacks 116 (not labelled in FIG. 10) that allow the consumer to access the telephonic network using the terminators 90-92. Such functionality is achieved by connecting the terminators 90-92 to a telephonic hub for sending and receiving signals to and from the telephonic network. In this embodiment the telephonic hub is a D-Mark Panel 94. The terminators 90-92 are also in optical communication with the 8-port POF switch 12, as they are in the system 10. The D-Mark Panel 94 represents the point at which the telephonic network owned by a telecommunications utility ends, and residential telephony wiring begins. In this sense, the functionality of the D-Mark Panel 94 is analogous to that of the modem 22, in that both the D-Mark Panel 94 and the modem 22 bridge an outside network or system (the telephonic network and the WAN 24, respectively) with a residential network or system (the residential telephony wiring and the LAN, respectively).

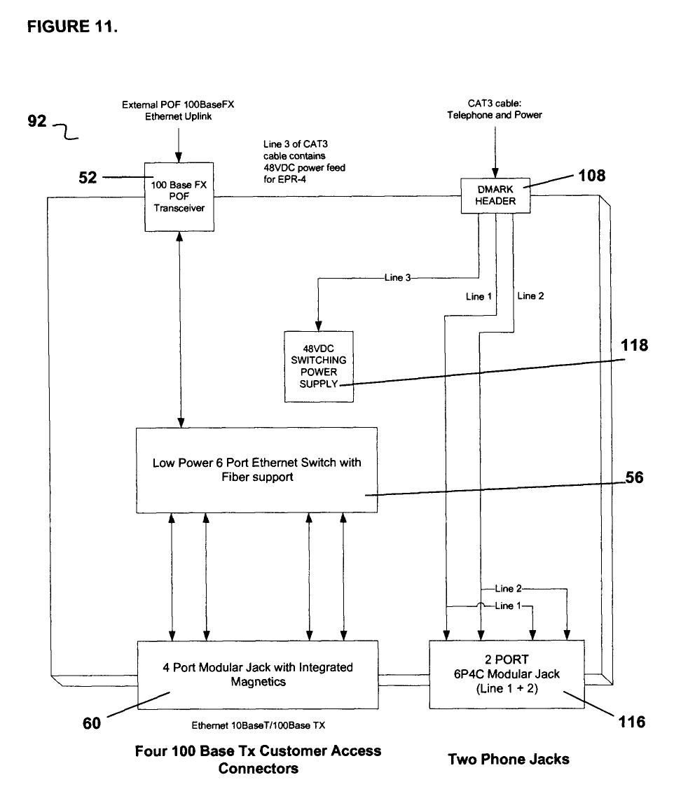

Referring now to FIG. 11, there is depicted a block diagram of the terminator 92 with telephony support. The terminator 92 has an electro-optical transceiver in the form of a 100 Base FX POF Transceiver 52 that corresponds in type and functionality to the POF transceiver 52 of the terminator 17. Similarly, the 6-port Ethernet switch 56 and the means for electrically conveying an electrical signal, which in this case is a network jack in the form of any of four RJ-45 jacks 60, correspond in type and functionality to those of the terminator 17. In contrast to the terminator 17, however, the terminator 92 with telephony support also has a telephonic network access port in the form of a D-Mark header 108 electrically coupled to a power supply contained within the terminator 92, which in this embodiment is a 48V DC switching power supply 118, and to a 2-port RJ-11(6P4C) modular telephone jack 116. Power supply wiring, labelled “Line 3” in FIG. 11, electrically couples the D-Mark header 108 to the power supply 118. Data wiring, labelled “Line 1” and “Line 2” in FIG. 11, electrically couple each port of the telephone jack 116 to the D-Mark header 108.

Fed into the D-Mark header 108 are pairs of wire from a telephone cable. The telephone cable is typically category 3 cable that makes up residential telephony wiring, each category 3 cable having three twisted pairs of wire. One twisted pair of wire (“power carrying wires”) is used to supply the terminator 92 with electric power. In FIG. 11, the power carrying wires are electrically coupled to the power supply wiring (labelled “Line 3”) when the telephone cable is coupled to the D-Mark header 108, thus providing 48V DC electric power to the terminator 92 by supplying DC power to the power supply 118. Power to the terminator 92 is drawn from a power adapter, which in this embodiment is a 48V DC power adapter 31 (present in FIG. 10). This power adapter 31 can be co-located with the 8-port POF switch 12 and is typically housed in a utility space in a building.

The power adapter 31 connects to the power carrying wires within the category 3 telephone cable to provide power to the terminator 92 when the category 3 telephone cable is coupled to the D-Mark header 105. In FIG. 11, data wiring (labelled “Line 1” and “Line 2”) is coupled to the 2-port RJ-11 (6P4C) telephone jack 116, with the consumer being able to plug a telephone into each of the ports of the RJ-11 (6P4C) telephone jack 116 via a standard RJ-11 plug. Line 1 of the data wiring is coupled to one twisted pair of data carrying wires within the category 3 telephone cable, and Line 2 of the data wiring is coupled to another twisted pair of data carrying wires within the category 3 telephone cable.

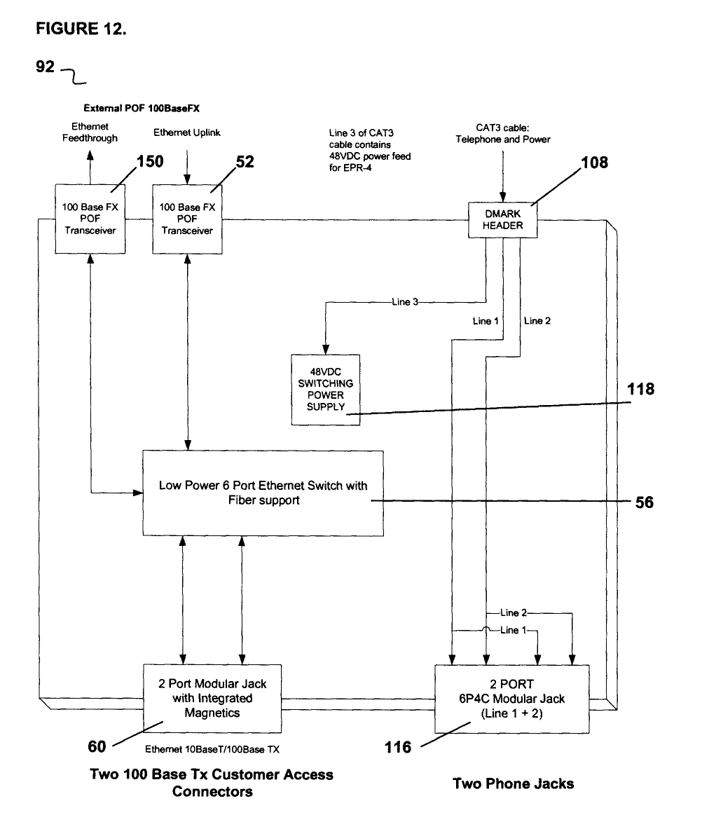

Referring now to FIG. 12, there is depicted a block diagram of the terminator 91 with telephony support. The terminator 91 has electro-optical transceivers in the form of the feedthrough transceiver 150 and the 100 Base FX POF Transceivers 52 that corresponds in type and functionality to the feedthrough transceiver 150 and the POF transceiver 152 of the terminator 18 without telephony support. Consequently, the feedthrough transceiver 150 can facilitate daisy-chaining of the terminators 90-92 just as the transceiver 150 in the terminator 18 can be used to enable daisy-chaining. The terminator 91 also has only two RJ-45 jacks 60 instead of the four RJ-45 jacks the terminator 90 has. The terminators 91, 92 are otherwise alike.

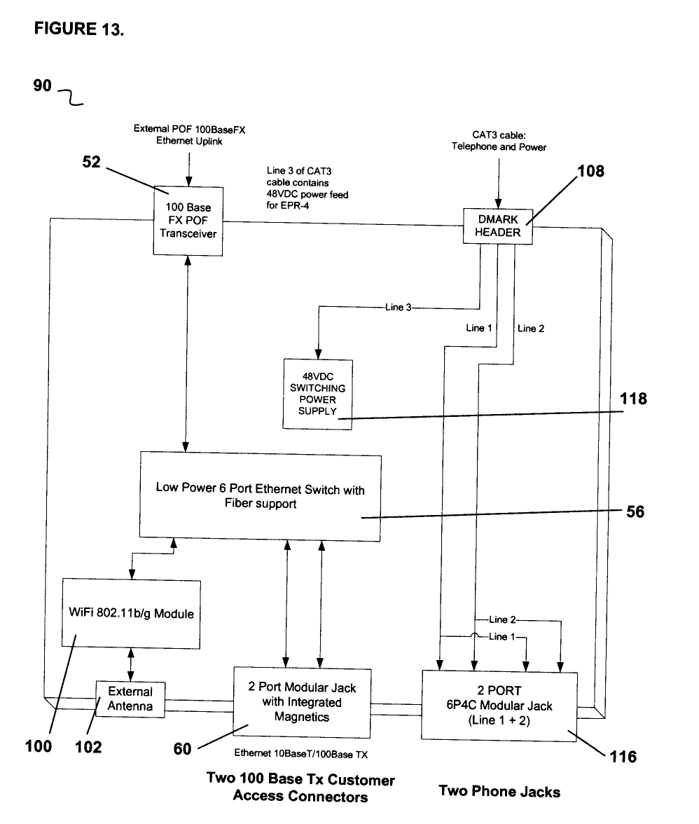

Referring now to FIG. 13, there is depicted a block diagram of the terminator 90 with telephony support that also supports wireless connectivity. The terminator 90 is the same as the terminator 91, with the exception that the terminator 90 lacks a feedthrough transceiver and, in its place, has means for electrically conveying an electrical signal, in the form of the wireless connectivity module in electrical communication with the external antenna 102 that protrudes from the terminator 19 and that facilitates wireless communication with the consumer device 21. The depicted wireless connectivity module is the Wi-Fi™ 802.11b/g module 100 such as a Broadcom BCM5352 chip-set or an Aethos AR5002AP-2X chip-set.

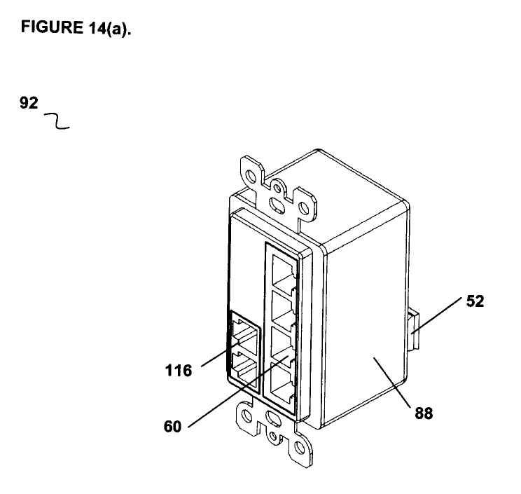

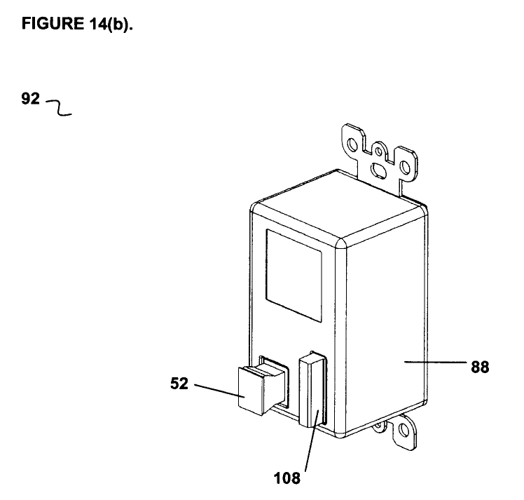

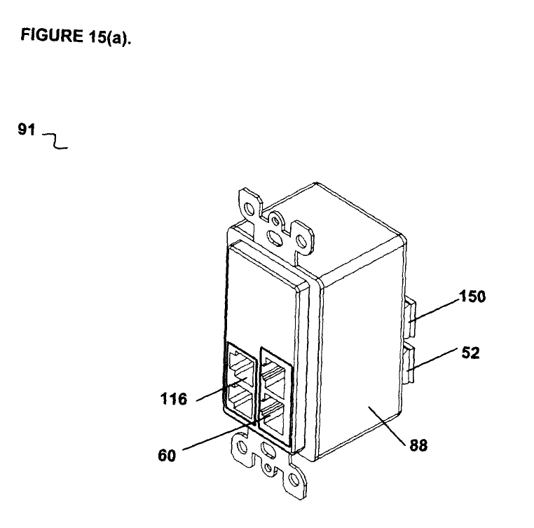

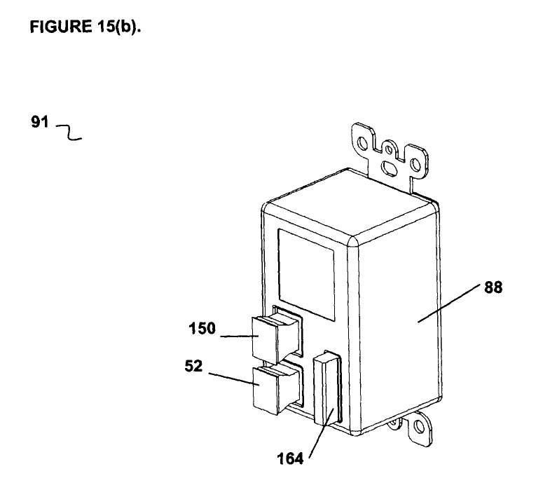

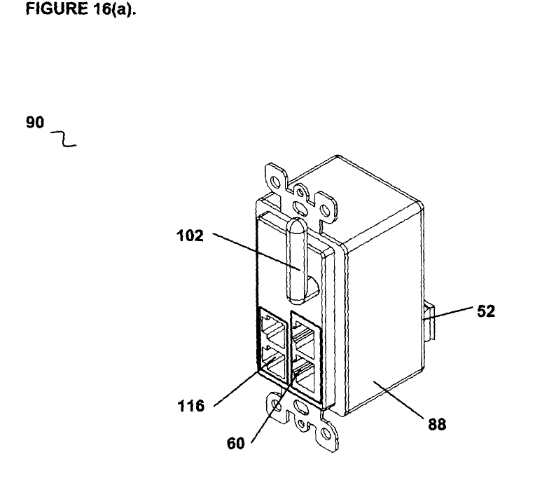

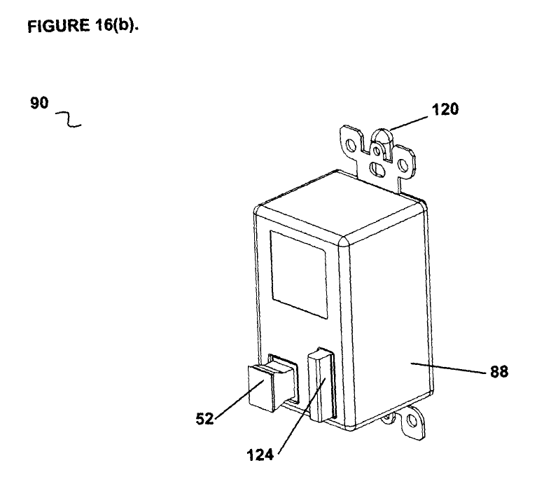

FIGS. 14-16 depict the terminators 90-92 mounted within the housing 88 that can be substantially concealed within a wall, thereby allowing easy and ubiquitous access to a high QOS network connection. The housing 88 is in connection with the POF transceiver 52 and the feedthrough transceiver 150 (for the terminator 91) and has the 6-port Ethernet switch 56 contained therein. Along with sharing the benefits of analogous terminators 17-19 as described with reference to FIGS. 7-9, an additional benefit of housing the terminators 90-92 within the housing 88 is that they can be used in lieu of a traditional telephony jack without any loss of functionality. I.e., a traditional telephony jack can be replaced with any of the terminators 90-92, with the result being that not only is access to the telephony system still available, but access to a wired or wireless high QOS Ethernet connection is also available.

One design challenge that had to be overcome in order to fit terminators 15-20, 90-92 within the housings 64, 88 and gangbox 89 is that of using space efficiently. With respect specifically to the terminators 17-20, 90-92 contained within the housings 88 and gangbox 89, using the feedthrough transceivers 150 and the POF transceivers 52 is advantageous, as the 6-port Ethernet switches 56 have integrated PHY-level drives for interfacing with the feedthrough transceiver 150 and the POF transceivers 52, thus obviating the need for a discrete PHY transceiver and thereby saving space. Separate PHY chips, such as a Marvell™ 88E3015 transceiver, would have had to be used to transmit Ethernet signals transmitted solely via electrical RJ-45 jacks instead of POF transceivers, which would have resulted in terminators having a form factor too large to fit within the housing 88. In the exemplary embodiments described herein, the housing 88 that can be housed within a wall is a Hubbell model 2001 R box, which measures 3.5″ high×2″ wide×2″ deep. The housing 64 that can be plugged into an AC power outlet measures 3.5″ in diameter and is 1″ thick.

Additionally, in order to use space efficiently, the circuitry used in the terminators 17-20, 90-92 is mounted on two different printed circuit boards (PCBs). The first PCB is a networking circuitry PCB, on which is mounted components through which the electrical Ethernet signal passes such as the POF transceiver 52, the feedthrough transceiver 150, the 6-port Ethernet switch 56, the RJ-45 jacks 60, the Fast Ethernet Transceiver 186, the Wi-Fi™ 802.11b/g module 100, and the external antenna 102. The second PCB is a power circuitry PCB on which is mounted components for providing power to the networking circuitry PCB, such as the power supply 62, 118 and the D-Mark header 108. The telephone jacks 116 are also mounted on the power circuitry PCB. The power circuitry PCB and networking circuitry PCB are stacked on each other within the housings 64, 88.

While a particular embodiment of the present invention has been described in the foregoing, it is to be understood that other embodiments are possible within the scope of the invention and are intended to be included herein. It will be clear to any person skilled in the art that modifications of and adjustments to this invention, not shown, are possible without departing from the spirit of the invention as demonstrated through the exemplary embodiment. The invention is therefore to be considered limited solely by the scope of the appended claims.

1. A media converter comprising:
(a) an electro-optical transceiver configured to convert an optical signal into an electrical signal and vice-versa, the electro-optical transceiver having:
(i) an optical signal port connectable to a plastic optical fiber, the optical signal port for sending and receiving the optical signal along the plastic optical fiber;
(ii) an electrical signal port for sending and receiving the electrical signal;
(b) a plurality of means for electrically conveying the electrical signal;
(c) a switch in electrical communication with the electrical signal port of the electro-optical transceiver and with the plurality of means for electrically conveying the electrical signal, the switch configured to direct the electrical signal from the electro-optical transceiver to any one of the means for electrically conveying the electrical signal and vice-versa, thereby facilitating bi-directional communication;
(d) a telephonic network access port connectable to a telephone cable, the telephone cable comprising a pair of power carrying wires for carrying electrical power;
(e) a power supply in electrical communication with the switch and the electro-optical transceiver; and
(f) power supply wiring electrically coupled to the telephonic network access port and to the power supply for powering the media converter by transmitting power from the power carrying wires to the power supply when the telephone cable is coupled to the network access port.

2. A media converter as claimed in claim 1 wherein:
(a) the telephone cable further comprises a pair of data carrying wires for transmitting telephonic data; and
(b) the media converter further comprises:
(i) a telephone jack;
(ii) data wiring electrically coupling the telephone jack to the pair of data carrying wires when the telephone cable is coupled to the network access port, thereby facilitating telephonic communication.

3. A media converter as claimed in claim 1 further comprising a feedthrough transceiver configured to convert a second optical signal into a second electrical signal and vice-versa, the feedthrough transceiver having:
(a) an optical signal port connectable to a second plastic optical fiber, the optical signal port for sending and receiving the second optical signal along the second plastic optical fiber;
(b) an electrical signal port for sending and receiving the second electrical signal;
and wherein the switch is in electrical communication with the electrical signal port of the feedthrough transceiver and is further configured to direct the electrical signal from the electrical signal port of the electro-optical transceiver to the electrical signal port of the feedthrough transceiver, thereby facilitating daisy-chaining of media converters via the feedthrough transceiver.

4. A media converter as claimed in claim 1 wherein the means for electrically conveying the electrical signal comprises:
(a) a wireless connectivity module in electrical communication with the switch; and
(b) an antenna in electrical communication with the wireless connectivity module.

5. A media converter as claimed in claim 1 wherein the means for electrically conveying the electrical signal comprises a network jack in electrical communication with the switch and configured to be electrically coupled to a cable for conveying the electrical signal.

6. A media converter comprising:
(a) a housing;
(b) a networking circuitry printed circuit board inside the housing and having mounted thereon:
(i) an electro-optical transceiver and configured to convert an optical signal into an electrical signal and vice-versa, the electro-optical transceiver having:
(A) an optical signal port protruding through the housing and connectable to a plastic optical fiber, the optical signal port for sending and receiving the optical signal along the plastic optical fiber;
(B) an electrical signal port contained within the compact housing for sending and receiving the electrical signal;
(ii) a plurality of means for electrically conveying the electrical signal; and
(iii) a switch in electrical communication with the electrical signal port of the electro-optical transceiver and with the plurality of means for electrically conveying the electrical signal, the switch configured to direct the electrical signal from the electro-optical transceiver to any one of the means for electrically conveying the electrical signal and vice-versa, thereby facilitating bi-directional communication; and
(c) a power circuitry printed circuit board inside the housing and having mounted thereon a power supply in electrical communication with the switch and the electro-optical transceiver,
wherein the power circuitry printed circuit board and the networking circuitry printed circuit board are stacked on each other within the housing.

7. A media converter as claimed in claim 6 further comprising an electrical plug in electrical communication with the power supply and for insertion into a power outlet, the electrical plug protruding from the housing such that when the electrical plug is inserted into the power outlet, the housing is pressed flush against the power outlet.

8. A media converter as claimed in claim 6 further comprising electrical contacts in electrical communication with the power supply and disposed on the housing.

9. A media converter as claimed in claim 8 wherein the housing has a height of about 2.7 inches, a width of about 3.8 inches and a depth of about 1.6 inches and wherein the media converter further comprises a power outlet disposed on a faceplate of the housing and in electrical communication with the electrical contacts.

10. A media converter as claimed in claim 6 wherein:
(a) the networking circuitry printed circuit board has further mounted thereon a feedthrough transceiver configured to convert a second optical signal into a second electrical signal and vice-versa, the feedthrough transceiver having:
(i) an optical signal port protruding through the housing and connectable to a second plastic optical fiber, the optical signal port for sending and receiving the second optical signal along the second plastic optical fiber;
(ii) an electrical signal port for sending and receiving the second electrical signal;
(b) the power supply is in electrical communication with the feedthrough transceiver; and
(c) the switch is in electrical communication with the electrical signal port of the feedthrough transceiver and is further configured to direct the electrical signal from the electrical signal port of the electro-optical transceiver to the electrical signal port of the feedthrough transceiver, thereby facilitating daisy-chaining of media converters via the feedthrough transceiver.

11. A media converter as claimed in claim 6 wherein:
(a) the means for electrically conveying the electrical signal comprises:
(i) a wireless connectivity module in electrical communication with the switch; and
(ii) an antenna in electrical communication with the wireless connectivity module; and
(b) the power supply is in electrical communication with the wireless connectivity module.

12. A media converter as claimed in claim 6 wherein the means for electrically conveying the electrical signal comprises a network jack in electrical communication with the switch and configured to be electrically coupled to a cable for conveying the electrical signal.

13. A system for facilitating bi-directional communication between a media converter and a packet-switched network, the system comprising:
(a) a network hub comprising:
(i) a network communication port in communication with the packet-switched network;
(ii) a plurality of network hub electro-optical transceivers configured to convert an optical signal into an electrical signal and vice-versa, each network hub electro-optical transceiver having:
(A) an optical signal port connectable to a plastic optical fiber, the optical signal port for sending and receiving the optical signal along the plastic optical fiber;
(B) an electrical signal port for sending and receiving the electrical signal;
(iii) a network hub switch in electrical communication with the network communication port and in electrical communication with the electric signal ports of the plurality of network hub switch electro-optical transceivers, the network hub switch configured to direct the electrical signal from the network communication port to any one of the network hub electro-optical transceivers and vice-versa, thereby facilitating bi-directional communication;
(b) a media converter as claimed in claim 1; and
(c) plastic optical fiber optically coupled at one end to the media converter and at another end to the network hub.

14. (canceled)
